(19) United States
(12) Patent Application Publication
(10) Pub. No.: US 2015/0304177 A1
(43) Pub. Date: Oct. 22, 2015

(54) PROCESSOR MANAGEMENT BASED ON APPLICATION PERFORMANCE DATA

(71) Applicant: Advanced Micro Devices, Inc., Sunnyvale, CA (US)

(72) Inventors: Joseph L. Greathouse, Austin, TX (US); Indrani Paul, Round Rock, TX (US)

(73) Assignee: Advanced Micro Devices, Inc., Sunnyvale, CA (US)

(21) Appl. No.: 14/255,137

(22) Filed: Apr. 17, 2014

(51) Int. Cl. H04L 12/26; H04L 12/24

(52) U.S. Cl. CPC H04L 43/04; H04L 41/5009; H04L 43/08

(57) ABSTRACT

Application performance data that indicates a level of service provided in executing one or more applications is determined in software running on one or more processor cores in a computing system that executes the one or more applications. The application performance data is provided to a controller in the computing system that is distinct from the one or more processor cores.

### TECHNICAL FIELD

The present embodiments relate generally to management of the operation of computing systems, and more specifically to collection of performance data for a computing system.

### BACKGROUND

A data center may be operated by a service provider that provides computing services to customers in a manner referred to, for example, as cloud computing or software as a service (SaaS). This provisioning of computing services may be governed by a contract called a service-level agreement (SLA). The SLA includes various specifications for running a customer application in the data center, thus specifying a minimum level of service that the service provider agrees to provide when running the customer application. In addition to trying to comply with SLAs, a service provider will try to minimize its operating costs. For example, the service provider will try to minimize running compute-intensive workloads at times when the cost of electricity is high, while still complying with its SLAs.

Operating parameters of processors used in a service provider's computing system may be adjusted in an attempt to optimize performance. For example, a processor may increase its clock frequency to improve performance if thermal headroom is available. Such adjustments may lead to undesirable results for the service provider, however. For example, thermal headroom may be available because the system has intentionally reduced its workload to reduce power consumption at a time of high electricity cost. Increasing the clock frequency in response to the available thermal headroom increases power consumption, which is directly contrary to the goal of reducing power consumption.

### SUMMARY OF ONE OR MORE EMBODIMENTS

In some embodiments, a method of managing processor operation includes determining application performance data that indicates a level of service provided in executing one or more applications. The application performance data is determined in software running on one or more processor cores in a computing system that executes the one or more applications. The application performance data is provided to a controller in the computing system that is distinct from the one or more processor cores.

In some embodiments, a computing system includes one or more processor cores, a controller distinct from the one or more processor cores, a storage element accessible to the controller, and a memory storing software configured for execution by the one or more processors. The software includes instructions to execute one or more applications, instructions to determine application performance data that indicates a level of service provided in executing the one or more applications, and instructions to store the application performance data in the storage element.

In some embodiments, a non-transitory computer-readable storage medium stores firmware configured for execution by a controller in a computing system. The computing system includes the controller, a storage element accessible to the controller, and one or more processor cores that are distinct from the controller. The firmware includes instructions to obtain application performance data from the storage element. The application performance data indicates a level of service provided in executing one or more applications on the one or more processor cores. The firmware also includes instructions to specify or request a hardware parameter for a first processor core of the one or more processor cores based at least in part on the application performance data.

### BRIEF DESCRIPTION OF THE DRAWINGS

The present embodiments are illustrated by way of example and are not intended to be limited by the figures of the accompanying drawings.

FIG. 1 is a block diagram of a distributed computing system in accordance with some embodiments.

FIG. 2 is an example of an integrated circuit in a processing node in the distributed computing system of FIG. 1 in accordance with some embodiments.

FIG. 3 is a block diagram of a motherboard in a processing node in the distributed computing system of FIG. 1 in accordance with some embodiments.

FIG. 4 is a block diagram of a processing node in the distributed computing system of FIG. 1 in accordance with some embodiments.

FIG. 5 is a flowchart of a method of managing processor operation in accordance with some embodiments.

Like reference numerals refer to corresponding parts throughout the figures and specification.

### DETAILED DESCRIPTION

Reference will now be made in detail to various embodiments, examples of which are illustrated in the accompanying drawings. In the following detailed description, numerous specific details are set forth in order to provide a thorough understanding of the disclosure. However, some embodiments may be practiced without these specific details. In other instances, well-known methods, procedures, components, and circuits have not been described in detail so as not to unnecessarily obscure aspects of the embodiments.

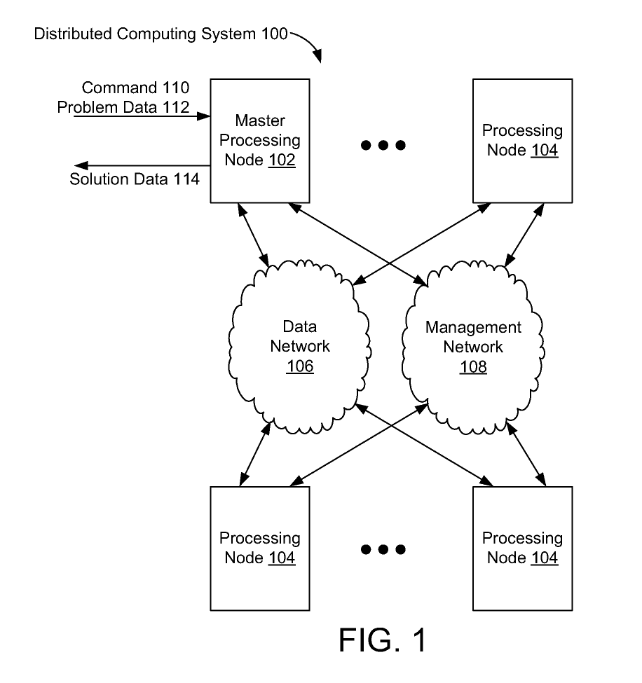

FIG. 1 is a block diagram of a distributed computing system 100 in accordance with some embodiments. The distributed computing system 100 includes a master processing node 102 coupled to a plurality of processing nodes 104 through a data network 106 and a management network 108 in accordance with some embodiments. The topology of the data network 106 and management network 108, and thus the topology in which the processing nodes 104 are coupled to each other and to the master processing node 102, may vary between different embodiments.

In some embodiments, the distributed computing system 100 is implemented in a data center. The master processing node 102 and/or each processing node 104 may correspond to a respective computing device. For example, the master processing node 102 and processing nodes 104 are server computers (e.g., blade servers) in a data center.

The distributed computing system 100 may be operated by a service provider that makes the distributed computing system 100 available to customers while being responsible for administering and maintaining the distributed computing system 100. In some embodiments, the service provided by such a service provider is referred to as cloud computing and/or software as a service (SaaS). The distributed computing system 100 thus may run one or more customer-specific applications. For example, the master processing node 102 may partition a workload for an application and distribute the workload, as partitioned, among the plurality of processing nodes 104 through the data network 106. Different processing nodes 104 perform different portions of the workload. The master processing node 102 may distribute a portion of the workload to itself, such that it also performs a portion of the workload. Alternatively, the master processing node 102 partitions the workload but does not process any portion of the workload itself. In the example of FIG. 1, the master processing node 102 receives a command 110 and problem data 112 associated with the command 110. The master processing node 102 partitions the problem data 112 and distributes portions of the problem data 112, as partitioned, through the data network 106 to respective processing nodes 104 for processing. The respective processing nodes 104 provide the results of processing their respective portions of the problem data 112 to the master processing node 102 through the data network 106, which processes (e.g., combines) the results and produces solution data 114 accordingly. The master processing node 102 and/or respective processing nodes 104 may collect data that indicates a level of service provided by the distributed computing system 100 in executing applications; this data is collected from other processing nodes 104 through the management network 108.

An application running on the distributed computing system 100 may operate in accordance with a service-level agreement (SLA) between the service provider and customer. The SLA is a contract that specifies a minimum level of service (e.g., level of performance) that the service provider agrees to satisfy when running one or more customer applications. For example, an SLA may include a set of specifications relating to factors such as throughput, latency, and system availability. An example of a specification relating to throughput is that the distributed computing system 100 must complete a specified number of operations (e.g., of database transactions) during a specified interval (e.g., a specified number of seconds). (A database transaction in this context is a software-defined unit of work associated with accessing a database, such as answering a database query or performing an atomic write to a database.) The specified number of operations to be completed during the specified interval may vary over time (e.g., over the course of the day, such that a higher throughput is guaranteed at peak hours than at off-peak hours). An example of a specification relating to latency is that the distributed computing system 100 must respond to a specified percentage (e.g., all or a specified portion) of requests within a specified time (e.g., within a specified number of milliseconds). While this example is an example of a maximum bound on latency in responding to requests, an SLA may also specify a minimum bound on latency in responding to requests. For example, the SLA may specify an allowable amount of variation about a desired response time, and thus an allowable amount of jitter. An example of a specification relating to availability is that the distributed computing system 100 must have no more than a specified amount (e.g., a specified number of minutes) of downtime during a specified period of time (e.g., a year).

In addition to trying to comply with SLAs, a service provider will try to minimize its costs. For example, the cost of electricity may vary throughout the day. The service provider will try to minimize running compute-intensive workloads on the distributed computing system 100 during periods of high electricity cost, while still complying with its SLAs.

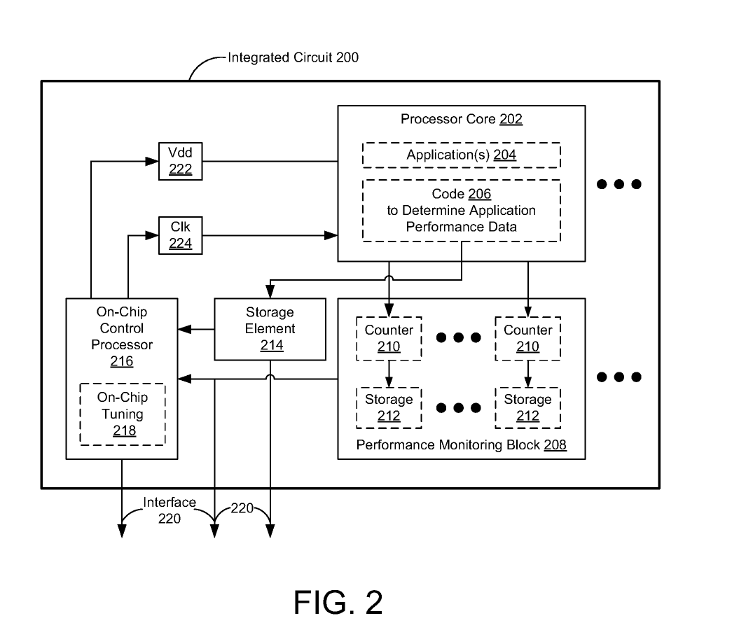

FIG. 2 is an example of an integrated circuit 200 (e.g., a processor) in a master processing node 102 or processing node 104 in the distributed computing system 100 (FIG. 1) in accordance with some embodiments. The integrated circuit 200 includes one or more processor cores 202. In some embodiments, the processor cores 202 (or a portion thereof) are central processing unit (CPU) cores, graphics processing unit (GPU) cores, or another type of processor core. In some embodiments, the processor cores 202 include a mix of different types of processor cores. For example, the processor cores 202 may include one or more CPU cores and one or more GPU cores.

Respective processor cores 202 are coupled to respective performance monitoring blocks 208 in the integrated circuit 200. Each performance monitoring block 208 monitors performance of a respective processor core 202. (Alternatively, multiple processor cores 202 are coupled to a single performance monitoring block 208 that monitors their performance.) The performance monitoring blocks 208 include performance counters 210 (and/or other performance monitors) that are used to determine processor-core performance data, which may also be referred to as processor core performance metrics or statistics. Examples of performance counters 210 include, but are not limited to, counters that count clock cycles for a processor core 202, committed instructions for a processor core 202, cache misses for a processor core 202, and branch mispredictions for a processor core 202. Values of the performance counters 210 are stored (e.g., periodically) in storage elements 212 (e.g., registers and/or one or more memory arrays). The performance monitoring block 208 may also (or alternatively) include power-monitoring circuitry to monitor the power currently being consumed by a respective processor core 202 and a storage element to store power consumption values as measured by the power monitoring circuitry. The performance monitoring blocks 208 are thus implemented in hardware in accordance with some embodiments.

The one or more processor cores 202 execute one or more applications 204 (e.g., customer applications). The processor-core performance data determined by the performance monitoring block(s) 208 (e.g., by the performance counters 210 and/or power-monitoring circuitry) provides information regarding operation of the processor core(s) 202 in the integrated circuit 200 while the one or more applications 204 are being executed. This information, however, is low-level information that does not correlate directly to a level of service provided by the one or more processor cores 202, and thus the distributed computing system 100 (FIG. 1), in executing the one or more applications 204. The processor-core performance data does not indicate whether an SLA is being satisfied or whether various specifications within an SLA are being satisfied. For example, while the performance monitoring block 208 may determine instructions per cycle (IPC) for a processor core 202, IPC does not correspond directly to throughput for an application 204. Throughput cannot be calculated based on IPC, since the IPC metric does not specify which instructions correspond to which application-level requests. Similarly, the processor-core performance data is not tied to particular transactions (e.g., database transactions) for the one or more applications 204.

The integrated circuit 200 also includes an on-chip control processor 216, which is distinct from the one or more processor cores 202. (The on-chip control processor 216 is said to be “on-chip” because it is in the same integrated circuit 200, and thus on the same chip, as the one or more processor cores 202.) In some embodiments, the on-chip control processor 216 has an instruction-set architecture (ISA) distinct from the ISA(s) of the one or more processor cores 202. Processor-core performance data as determined in the performance monitoring block(s) 208 may be provided to the on-chip control processor 216. The on-chip control processor 216 may select and specify one or more hardware parameters for a processor core 202 based at least in part on the processor-core performance data for the processor core 202. For example, the on-chip control processor 216 specifies a power supply voltage level to be provided to the processor core 202 by a power supply 222 and/or a frequency of a clock signal to be provided to the processor core 202 by a clock 224. (While the power supply 222 is shown as being part of the integrated circuit 200, it may be external to the integrated circuit 200.)

Alternatively, or in addition, the on-chip control processor 216 specifies one or more configuration values that are internal to a processor core 202. For example, the on-chip control processor 216 specifies a number of active processing units and/or other active elements (e.g., number of enabled caches and/or number of enabled error-checking circuits) in the processor core 202. In another example, the on-chip control processor 216 modifies the size of one or more elements of the processor core 202 (e.g., the size of a cache). In still another example, the on-chip control processor 216 selects between two elements of the processor core 202 that perform the same function but with different speeds and power consumption (e.g., such that the first element performs a function more quickly than the second element, but with higher power consumption that the second element). These examples may be combined in accordance with some embodiments. Still other examples are possible.

In some embodiments, on-chip tuning firmware 218 running on the on-chip control processor 216 selects and specifies the one or more hardware parameters for a processor core 202 based at least in part on the processor-core performance data for the processor core 202. The power supply voltage level and/or clock frequency may change dynamically during operation of the integrated circuit 200, as specified by the on-chip control processor 216 (e.g., by the on-chip tuning firmware 218). Similarly, the one or more configuration values that are internal to a processor core 202 (e.g., that specify a number of active processing units and/or other active elements, that specify a size of one or more elements, and/or that select between two elements that perform the same function) may change dynamically during operation of the integrated circuit 200, as specified by the on-chip control processor 216 (e.g., by the on-chip tuning firmware 218).

In some embodiments, the processor core 202 may be operated in any of a plurality of performance states as specified by the on-chip control processor 216 (e.g., by the on-chip tuning firmware 218). Each performance state may correspond to a respective combination of power supply voltage level (“supply voltage”) and clock frequency. The performance states may be defined, for example, in accordance with the Advanced Configuration and Power Interface (ACPI) specification. Available performance states for the processor core 202 may be labeled P0, P1, . . . , Pn, where n is a non-negative integer. The P0 state has the highest supply voltage and/or clock frequency and thus the highest performance and highest power consumption. Successive performance states P1 through Pn have successively smaller supply voltages and/or clock frequencies, and thus have successively lower performance but also successively lower power consumption. The performance state of a processor core 202 may be changed dynamically during operation, as specified by the on-chip control processor 216 (e.g., by the on-chip tuning firmware 218).

As discussed, the on-chip control processor 216 may select and specify one or more hardware parameters for a processor core 202 based at least in part on the processor-core performance data for the processor core 202, as provided by a corresponding performance monitoring block 208. Selecting hardware parameters for a processor core 202 based only on processor-core performance data, however, is problematic. First, as previously discussed, processor-core performance data does not correspond directly to application performance data. Second, selecting hardware parameters for a processor core based only on processor-core performance data may lead to undesirable results. For example, the workload allocated to a particular processing node 104 may be throttled back when the price of electricity is high, to reduce energy costs. The on-chip control processor 216 may conclude, in response to a resulting change in the processor-core performance data, that overhead exists to run the one or more processor cores 202 at higher frequencies and/or higher power supply voltage levels, and may specify a higher performance state accordingly, thus increasing power consumption. This increase in power consumption is directly contrary to the service provider's goal of reducing energy costs.

To avoid such undesirable results, one or more processor cores 202 execute software code 206 to determine application performance data that indicates a level of service provided in executing the application(s) 204. The application performance data includes one or more software-defined statistics (e.g., end-user performance metrics). In some embodiments, the application performance data includes statistics that measure such factors as throughput and/or latency and that may be compared to specifications in an SLA to determine compliance with the SLA. Alternatively, or in addition, the application performance data may include an aggregate indicator of compliance with multiple specifications associated with an application 204 or multiple applications 204. For example, the application performance data may specify whether the system 100 (or a portion thereof) is in compliance with an SLA. In some embodiments, the code 206 is user-level code, as is the code for the one or more applications 204. Alternatively, the code 206 is supervisor-level code (e.g., along with operating system and/or hypervisor code), and thus is privileged.

The application performance data as determined through execution of the code 206 may be provided to the on-chip control processor 216. For example, the application performance data is stored in a storage element 214 (e.g., a register, set of registers, or memory array) in the integrated circuit 200 that is accessible by the on-chip control processor 216. (While the storage element 214 is shown being separate from the processor core(s) 202 and performance monitoring block 208, it may alternatively be included in a processor core 202 or performance monitoring block 208.) In some embodiments, the processor core 202 that stores the application performance data in the storage element 214 sends an interrupt to the on-chip control processor 216 indicating that the application performance data is available. The on-chip control processor 216 reads the application performance data from the storage element 214 in response to the interrupt. Alternatively, the on-chip control processor 216 reads the application performance data from the storage element 214 without an interrupt having been sent by the processor core 202. For example, the on-chip control processor 216 polls the storage element 214 to determine whether the application performance data is available or periodically reads the storage element 214 (e.g., in response to interrupts that do not come from the processor core 202).

The on-chip control processor 216 (e.g., the on-chip tuning firmware 218) selects and specifies one or more hardware parameters (e.g., a supply voltage or clock frequency) (e.g., a performance state) (e.g., a configuration value internal to the processor core 202) for a processor core 202 based at least in part on the application performance data. The on-chip control processor 216 (e.g., the on-chip tuning firmware 218) may select and specify the one or more hardware parameters based further on processor-core performance data for the processor core 202 and/or on other factors (e.g., on system data such as temperature and/or energy costs). For example, the supply voltage and/or clock frequency of a processor core 202 are increased if the application performance data indicates a lack of compliance with an SLA (or marginal compliance that does not satisfy a threshold) and if the processor-core performance data and/or system data indicate that sufficient overhead is available. However, the supply voltage and/or clock frequency of a processor core 202 are not increased if the application performance data indicates compliance (e.g., by a defined margin) with an SLA, even if the processor-core performance data and/or system data indicate that sufficient overhead for an increase is available. Furthermore, the supply voltage and/or clock frequency of a processor core 202 may be increased by an amount that minimizes energy costs while ensuring compliance with an SLA (e.g., assuming that the processor-core performance data and/or system data indicate that sufficient overhead is available.) These are merely some examples; other examples are possible.

The integrated circuit 200 may include an external interface 220 coupled to the on-chip control processor 216, storage element 214, and/or performance monitoring block 208 (and in some embodiments to the processor core 202 as well). In some embodiments, the interface 220 is a sideband interface that operates independently of an operating system running on the one or more processor cores 202, such that the operating system is not aware of communications through the interface 220. (While shown as separate connections in FIG. 2, the interface 220 may be a single bus.)

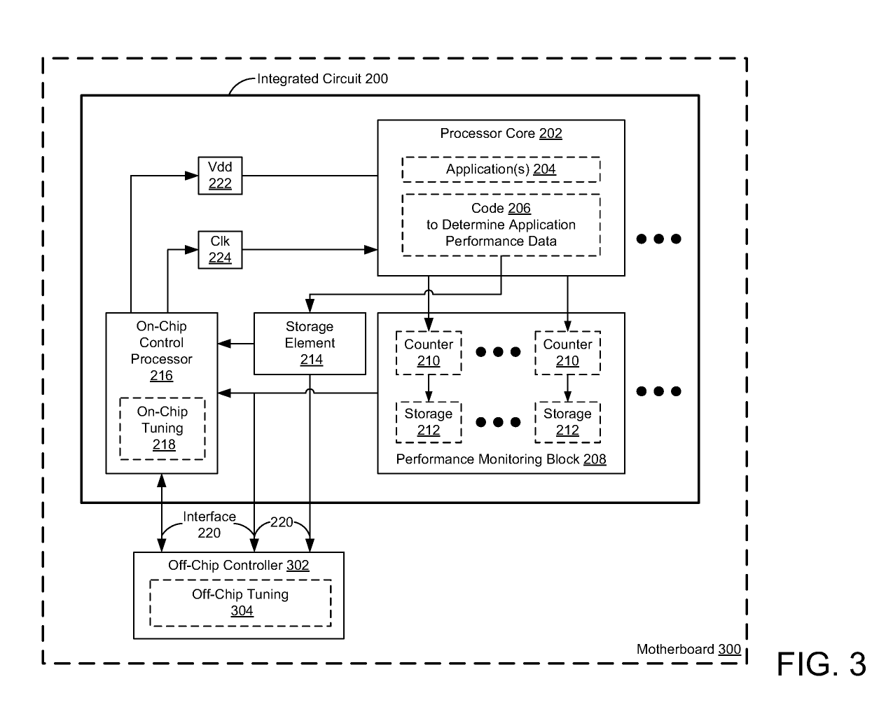

FIG. 3 is a block diagram of a motherboard 300 in a processing node 104 (or master processing node 102) in the distributed computing system 100 (FIG. 1) in accordance with some embodiments. The integrated circuit 200 is mounted on the motherboard 300, as is an off-chip controller 302. (Other circuitry on the motherboard 300 is not shown for simplicity.) In some embodiments, the off-chip controller 302 is a Baseboard Management Controller (BMC). The off-chip controller 302 is coupled to the integrated circuit 200 through the interface 220 (e.g., a sideband interface). The off-chip controller 302 is said to be “off-chip” because it is in a different integrated circuit than the one or more processor cores 202.

The application performance data as determined through execution of the code 206 may be provided to the off-chip controller 302. For example, the application performance data is stored in the storage element 214, which is accessible by the off-chip controller 302 through the interface 220. In some embodiments, the processor core 202 that stores the application performance data in the storage element 214 sends an interrupt to the off-chip controller 302 indicating that the application performance data is available. The off-chip controller 302 reads the application performance data from the storage element 214 in response to the interrupt. Alternatively, the off-chip controller 302 reads the application performance data from the storage element 214 without an interrupt having been sent by the processor core 202. For example, the off-chip controller 302 polls the storage element 214 to determine whether the application performance data is available or periodically reads the storage element 214 (e.g., in response to interrupts that do not come from the processor core 202). In some embodiments, the processor-core performance data is also provided to the off-chip controller 302 through the interface 220 (e.g., from the performance monitoring block 208 or on-chip control processor 216).

The off-chip controller 302 may send a request to the on-chip control processor 216 requesting implementation of one or more hardware parameters (e.g., a supply voltage or clock frequency) (e.g., a performance state) (e.g., a configuration value internal to the processor core) for a processor core 202 based at least in part on the application performance data. The request may be based further on processor-core performance data for the processor core 202 and/or on other factors (e.g., on system data such as temperature and/or energy costs). In some embodiments, the request is generated by off-chip tuning firmware 304 running on the off-chip controller 302. The on-chip control processor 216 may specify the one or more hardware parameters for the processor core 202 in response to the request.

The off-chip controller 302 may collect application performance data from multiple integrated circuits 200 on multiple motherboards 300 in respective processing nodes 104 (and, in some embodiments, in the master processing node 102) of the system 100. This collection may be performed, for example, through the management network 108 (FIG. 1), which may couple off-chip controllers 302 on different motherboards 300 in different processing nodes 104 (and, in some embodiments, in the master processing node 102). Collecting application performance data in this manner permits evaluation of how well the entire distributed computing system 100 is complying with SLAs. The results of this evaluation may be communicated back to off-chip controllers 302 on different motherboards 300, which may issue requests to respective on-chip control processors 216, based at least in part on the results, to implement specified hardware parameters (e.g., performance states) on respective processor cores 202.

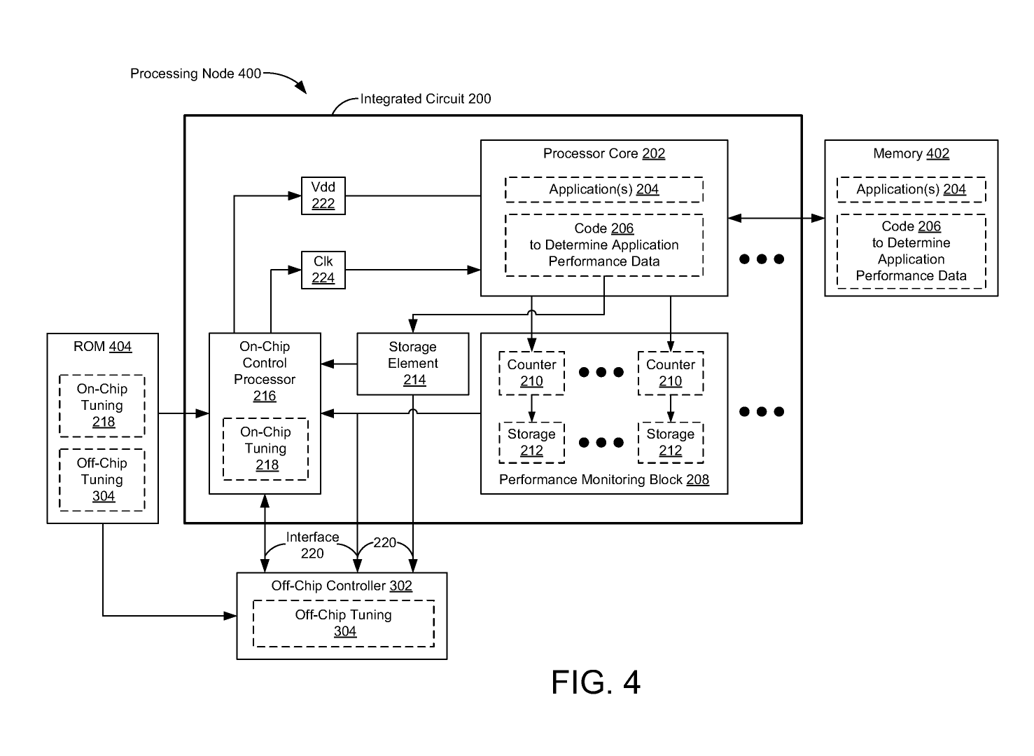

FIG. 4 is a block diagram of a processing node 400 in the distributed computing system 100 (FIG. 1) in accordance with some embodiments. The processing node 400 is an example of a processing node 104 or master processing node 102 (FIG. 1) and includes an integrated circuit 200 (FIGS. 2 and 3) and off-chip controller 302 (FIG. 3). The processor core(s) 202 in the integrated circuit 200 are coupled to a memory 402 (e.g., through a memory controller and input/output memory management unit, not shown). The memory 402 includes a non-transitory computer-readable storage medium (e.g., a hard-disk drive, solid-state drive, or other nonvolatile memory) that stores one or more programs with instructions configured for execution by the processor core(s) 202. The one or more programs include code for the one or more applications 204 and the code 206 for determining application performance data. The one or more programs may include additional code (e.g., additional privilege code, such as operating system code and/or hypervisor code). The on-chip control processor 218 and the off-chip controller 302 are coupled to a read-only memory (ROM) 404, which includes a non-transitory computer-readable storage medium that stores one or more programs with instructions configured for execution by the on-chip control processor 216 and the off-chip controller 302. In some embodiments, the one or more programs stored in the ROM 404 include the on-chip tuning firmware 218, which is configured for execution by the on-chip control processor 216. In some embodiments, the one or more programs stored in the ROM 404 include the off-chip tuning firmware 304, which is configured for execution by the off-chip controller 302. While the on-chip tuning firmware 218 and off-chip tuning firmware 304 are shown as being stored in a single ROM 404, they may be stored in separate ROMs, in another type of nonvolatile memory device, in separate instances of other types of nonvolatile memory devices, or in the memory 402.

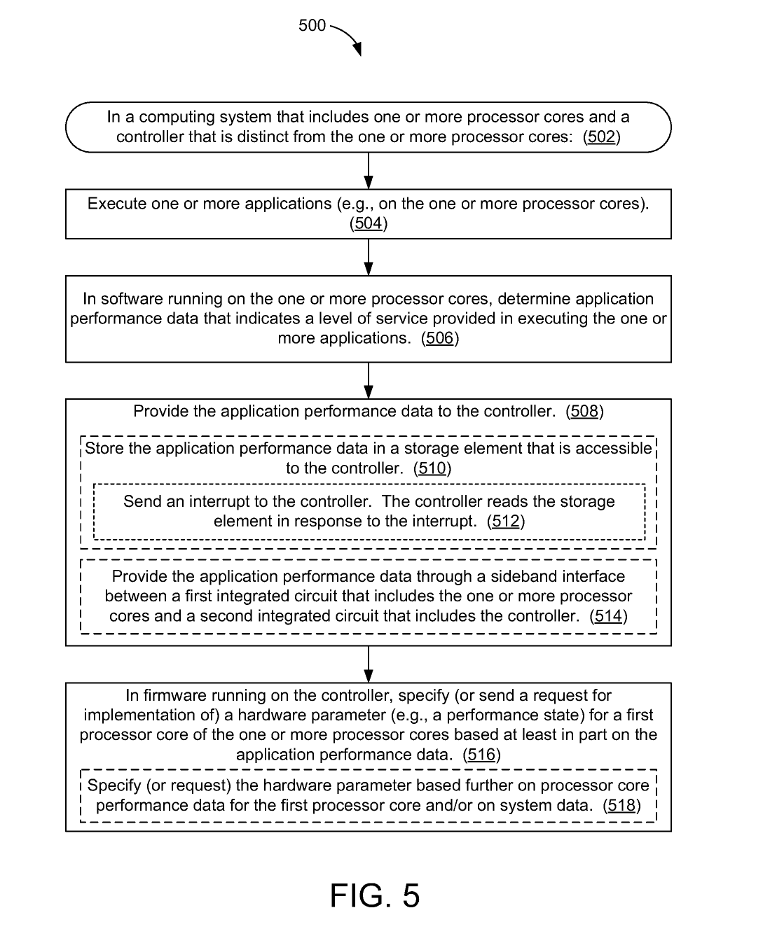

FIG. 5 is a flowchart of a method 500 of managing processor operation in accordance with some embodiments. The method 500 is performed (502) in a computing system that includes one or more processor cores (e.g., one or more processor cores 202, FIGS. 2-4) and a controller (e.g., an on-chip control processor 216, FIGS. 2-4, or off-chip controller 302, FIGS. 3-4) that is distinct from the one or more processor cores. (In some embodiments, the computing system includes multiple controllers. For example, the computing system may include both the on-chip control processor 216 and the off-chip controller 302, either of which may be “the controller” referenced in the following description of the method 500.) For example, the method 500 is performed in the distributed computing system 100 (FIG. 1).

In the method 500, one or more applications (e.g., applications 204) are executed (504) in the computing system (e.g., on one or more processor cores 202).

In software (e.g., code 206) running on the one or more processor cores, application performance data is determined (506) that indicates a level of service provided (e.g., by the computing system or a portion thereof) in executing the one or more applications. In some embodiments, the application performance data includes an indication of throughput for the one or more applications. In some embodiments, the application performance data includes an indication of latency for requests associated with the one or more applications. In some embodiments, the application performance data indicates a degree of compliance with one or more specifications in an SLA governing execution of the one or more applications by the computing system. In some embodiments, the application performance data includes an aggregate indicator of a degree of compliance with a plurality of specifications for execution of the one or more applications (e.g., of a degree of compliance with an entire SLA).

The application performance data is provided (508) to the controller (e.g., to the on-chip control processor 216 or off-chip controller 302). In some embodiments, the application performance data is stored (510) in a storage element (e.g., storage element 214) that is accessible to the controller. For example, an interrupt is sent (512) to the controller from a processor core, in response to which the controller reads the storage element. Alternatively, the application performance data is provided to the controller without an interrupt having been sent by the processor core. For example, the controller polls the storage element 214 to determine whether the application performance data is available or periodically reads the storage element 214 (e.g., in response to interrupts that do not come from the processor core).

In some embodiments, the application performance data is provided (514) through a sideband interface (e.g., interface 220) between a first integrated circuit (e.g., integrated circuit 200) that includes the one or more processor cores and a second integrated circuit that includes the controller (e.g., the off-chip controller 302).

In some embodiments, firmware (e.g., on-chip tuning firmware 218) running on the controller specifies (516) a hardware parameter (e.g., a supply voltage or clock frequency) (e.g., a performance state) (e.g., a configuration value internal to the processor core) for a first processor core of the one or more processor cores based at least in part on the application performance data. Specification of the hardware parameter may be further based (518) on processor-core performance data for the first processor core and/or on system data (e.g., temperature and/or energy costs). Alternatively, firmware (e.g., off-chip tuning firmware 304) running on the controller sends (516) a request for implementation of a hardware parameter for the first processor core, based at least in part on the application performance data. The request may be further based on processor-core performance data for the first processor core and/or on system data. This request is sent, for example, from the off-chip controller 302 to the on-chip control processor 216.

While the method 500 includes a number of operations that appear to occur in a specific order, it should be apparent that the method 500 can include more or fewer operations, which can be executed serially or in parallel. An order of two or more operations may be changed, performance of two or more operations may overlap, and two or more operations may be combined into a single operation. For example, all of the operations of the method 500 may overlap or be performed in a parallel in an ongoing manner.

The foregoing description, for purpose of explanation, has been described with reference to specific embodiments. However, the illustrative discussions above are not intended to be exhaustive or to limit all embodiments to the precise forms disclosed. Many modifications and variations are possible in view of the above teachings. The disclosed embodiments were chosen and described to best explain the underlying principles and their practical applications, to thereby enable others skilled in the art to best implement various embodiments with various modifications as are suited to the particular use contemplated.

What is claimed is:

1. A method of managing processor operation, comprising:
in software running on one or more processor cores in a computing system, determining application performance data that indicates a level of service provided in executing one or more applications; and
providing the application performance data to a controller in the computing system that is distinct from the one or more processor cores.

2. The method of claim 1, wherein the application performance data comprises at least one of an indication of throughput for the one or more applications and an indication of latency for requests associated with the one or more applications.

3. The method of claim 1, wherein the application performance data comprises an aggregate indicator of a degree of compliance with a plurality of specifications for execution of the one or more applications.

4. The method of claim 1, wherein the application performance data indicates a degree of compliance with one or more specifications in a service-level agreement governing execution of the one or more applications by the computing system.

5. The method of claim 1, wherein:
the one or more processor cores comprise a first processor core in an integrated circuit;
the controller comprises a control processor in the integrated circuit, wherein the control processor is distinct from the first processor core; and
providing the application performance data to the controller comprises storing the application performance data in a storage element that is accessible to the control processor.

6. The method of claim 5, wherein:
providing the application performance data to the controller further comprises sending an interrupt to the control processor; and
the control processor reads the storage element in response to the interrupt.

7. The method of claim 5, further comprising:
in firmware running on the control processor, specifying a hardware parameter for the first processor core based at least in part on the application performance data.

8. The method of claim 7, wherein specifying the hardware parameter for the first processor core comprises specifying a performance state for the first processor core, the performance state corresponding to a specified power supply level for the first processor core and a specified clock frequency for the first processor core.

9. The method of claim 7, wherein specifying the hardware parameter for the first processor core comprises specifying an active number of processing units for the first processor core.

10. The method of claim 7, further comprising:
using one or more performance monitors implemented in hardware in the integrated circuit, determining processor-core performance data for the first processor core; and
providing the processor-core performance data for the first processor core to the control processor;
wherein specifying the hardware parameter for the first processor core is further based on the processor-core performance data for the first processor core.

11. The method of claim 10, wherein determining the processor-core performance data comprises determining at least one parameter selected from the group consisting of a number of instructions committed for the first processor core, a number of branch mispredictions for the first processor core, a number of cache misses for the first processor core, and power consumption for the first processor core.

12. The method of claim 1, wherein:
the one or more processor cores comprise a first processor core in a first integrated circuit; and
the controller comprises a control processor in a second integrated circuit distinct from the first integrated circuit.

13. The method of claim 12, wherein providing the application performance data to the controller comprises providing the application performance data through a sideband interface between the first and second integrated circuits, wherein the sideband interface operates independently of an operating system for the first processor core.

14. The method of claim 12, further comprising:
in the control processor, selecting a desired hardware parameter for the first processor core based at least in part on the application performance data; and
sending a request for implementation of the desired hardware parameter from the second integrated circuit to the first integrated circuit.

15. A computing system, comprising:
one or more processor cores;
a controller distinct from the one or more processor cores;
a storage element accessible to the controller; and
a first memory storing one or more programs configured for execution by the one or more processors, the one or more programs comprising:
instructions to execute one or more applications;
instructions to determine application performance data that indicates a level of service provided in executing the one or more applications; and
instructions to store the application performance data in the storage element.

16. The computing system of claim 15, further comprising a second memory storing firmware configured for execution by the controller, the firmware comprising:
instructions to obtain the application performance data from the storage element; and
instructions to request or specify a hardware parameter for a first processor core of the one or more processor cores based at least in part on the application performance data.

17. The computing system of claim 15, comprising an integrated circuit that comprises the controller, the storage element, and at least one of the one or more processor cores.

18. The computing system of claim 15, comprising:
a first integrated circuit that comprises the storage element and at least one of the one or more processor cores;
a second integrated circuit that comprises the controller; and
a sideband interface coupling the first integrated circuit with the second integrated circuit, to provide the application performance data from the first integrated circuit to the second integrated circuit independently of an operating system for the one or more processor cores.

19. A non-transitory computer-readable storage medium storing firmware configured for execution by a controller in a computing system that comprises the controller, a storage element accessible to the controller, and one or more processor cores that are distinct from the controller, the firmware comprising:
instructions to obtain application performance data from the storage element, wherein the application performance data indicates a level of service provided in executing one or more applications on the one or more processor cores; and
instructions to request or specify a hardware parameter for a first processor core of the one or more processor cores based at least in part on the application performance data.

20. The computer-readable storage medium of claim 19, wherein the instructions to request or specify the hardware parameter for the first processor core based at least in part on the application performance data comprise instructions to request or specify the hardware parameter based further on processor-core performance data for the first processor core.
